(19) United States
(12) Patent Application Publication
(10) Pub. No.: US 2024/0401693 A1
(43) Pub. Date: Dec. 5, 2024

(54) LUBRICATION COOLING SYSTEM FOR AN ELECTRIC DRIVE MODULE AND EFFICIENT THERMAL MANAGEMENT

(71) Applicant: FCA US LLC, Auburn Hills, MI (US)

(72) Inventor: Meng Li, Lake Orion, MI (US)

(21) Appl. No.: 18/326,607

(22) Filed: May 31, 2023

(51) Int. Cl. F16H 57/04; H02K 5/20; H02K 7/116; H02K 9/193; H02K 9/26; H02K 11/25; H02K 11/30

(52) U.S. Cl. CPC F16H 57/0476; F16H 57/0413; F16H 57/0415; F16H 57/0436; H02K 5/203; H02K 7/116; H02K 9/193; H02K 9/26; H02K 11/25; H02K 11/30; F16H 2057/02034

(57) ABSTRACT

An electric drive lubrication cooling system includes a filter, an electric oil pump, an oil cooler, a pipe system, a one-way valve, an inlet of motor cooling plumbing, an outlet of motor cooling plumbing, motor end winding inner cooling channels, left and right oil ring channels, a shaft oil circuit, and sensor system including a sump oil temperature sensor, a motor cooling inlet temperature sensor, and a motor temperature sensor. The lubrication cooling system operates at different modes based on system temperatures to effectively cool and lubricate the components of the electric drive module by flow control to reduce the system power consumption.

### FIELD

The present application relates generally to lubrication and cooling systems for electric vehicles and, more particularly, to a lubrication and cooling system and method for an electric drive module of an electric vehicle.

### BACKGROUND

In an electric vehicle, the lubrication cooling system plays an important role for operation of the electric drive module. For example, the rotational components such as bearings and gears demand appropriate lubrication to reduce friction and surface wear, and the electric motor needs sufficient cooling to avoid thermal overload or derating at high power conditions. However, due to the transient operating conditions of speed, the flow requirements are continuously changed and not easily met by a constant oil supply. Moreover, if the system flow is excessive, the system power consumption is increased by component parasitic loss and pump loss, which negatively affects battery performance and efficiency of the electric vehicle.

In the prior art lubrication cooling systems, the heat dissipation of the electric motor is limited for the motor end windings, which are a major heat generating component. Secondly, lubrication and cooling flow are not well coordinated by oil budgeting and design of flow control, which causes difficulty in managing system flow accurately. Therefore, it is desirable to develop an improved, efficient lubrication cooling system that can meet the flow requirements of all the components in the electric drive module and achieve appropriate flow control with improved thermal management strategies.

### SUMMARY

Aiming at addressing the deficiencies in the prior art, the present application provides an improved lubrication cooling system of an electric drive module of an electric vehicle and an improved thermal management method. Not only can the improved lubrication cooling system and associated methodology effectively cool and lubricate the components of the electric drive system, but it can also precisely control and meet the flow requirements to reduce the power consumption of the electric drive system.

In one example aspect of the invention, the electric drive lubrication cooling system includes a filter, an electric oil pump, an oil cooler, a pipe system, a one-way valve, an inlet of motor cooling plumbing, an outlet of motor cooling plumbing, inner cooling channels of the motor end windings, left and right oil ring channels, a shaft oil circuit, and sensor system including a sump oil temperature sensor, a motor cooling inlet temperature sensor, and a motor temperature sensor.

The lubrication cooling system of the present application provides important benefits as compared to the prior systems including an aspect with two working modes through a concise topology, thereby satisfying different working requirements. At low and medium system temperatures, the power-saving mode shuts off the cooling of the motor end windings and provides the lubrication flow for the components in the gearbox. At high system temperatures, the high-power mode enables both the lubrication flow of the gearbox and the cooling flow of the motor, which assures the thermal safety.

According to an aspect, the motor winding is cooled with internal channels and the motor rotor is cooled by flow inside passages of the rotor shaft. For the motor stator cooling, internal channels are placed at the center of the stator slots and surrounded by the windings with direct contact, which facilitates heat extraction of the winding as the component of major heat generation in the electric motor. For rotor cooling, the heat generated by the rotor is conducted to the rotor shaft and hence effectively dissipated by the convective cooling flow of the passages.

According to an aspect, the control module realizes communication connection with the electric oil pump and the one-way valve. The control module controls the lubrication cooling flow by controlling the speed of the electric oil pump; the control module controls system operational state by controlling the open and close state of the first three-way valve; the control module controls system heat dissipation by determining the coolant flow state.

According to an aspect, the lubrication cooling system shuts off the cooling flow towards the motor end windings with a one-way valve and meets the lubrication flow requirements of the electric drive module with flow calculation and pump control.

According an aspect, the lubrication cooling system enables cooling flow towards the motor end windings with a one-way valve opening. Both the lubrication and cooling flow requirements of the electric drive module are met with flow calculation and pump control.

According to an aspect, the lubrication cooling system follows an intelligent thermal management strategy that determines the system operational state by comparing the sump oil temperature and the motor inlet oil temperature with relevant threshold values.

According an aspect, calculation of the lubrication flow meets the minimum flow requirement of the gearbox in the electric drive module; calculation of the electric motor cooling flow achieves appropriate motor temperature with reduced flow; and the total pump flow is determined by considering both the lubrication and cooling flow.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a high level schematic diagram of a lubrication cooling system according to an embodiment of the present application;

FIG. 2 is a three-dimensional schematic of the motor cooling channel geometry of FIG. 1 according to an embodiment of the present application;

FIG. 3 is a cross-section schematic of the motor cooling channels shown in FIG. 2 according to an embodiment of the present application;

FIG. 4 is a schematic diagram of the communication connection between the control module used in FIG. 1 and each actuator of the lubrication cooling system according to an embodiment of the present application;

FIG. 5 is a schematic internal structure diagram of the control module shown in FIG. 4 according to an embodiment of the present application;

FIG. 6 is a diagram of operation of the lubrication cooling system operation shown in FIG. 1 under the power-saving mode at low and medium system temperatures according to an embodiment of the present application;

FIG. 7 is a diagram of operation of the lubrication cooling system shown in FIG. 1 under the high-power mode at high system temperatures according to an embodiment of the present application; and

FIG. 8 is a control flow diagram of the lubrication cooling system shown in FIG. 1 and shows a high level operational control of each actuator according to an embodiment of the present application.

### DETAILED DESCRIPTION

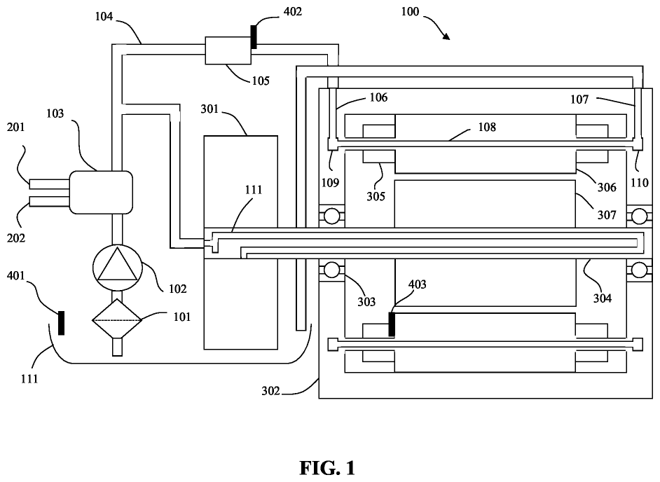

FIG. 1 illustrates a system schematic of an improved lubrication cooling system 100 by showing certain components and associated connections. In the example illustrated, the lubrication cooling system 100 includes the filter 101, the electric oil pump 102, the oil cooler 103 with coolant inlet 201 and outlet 202, the pipe system 104, the one-way valve 105, the inlet of motor cooling plumbing 106, the outlet of motor cooling plumbing 107, the inner cooling channels 108, the left oil ring channel 109, the right oil ring channel 110, the shaft oil circuit 111, and the sensor system comprising the sump oil temperature sensor 401, the motor cooling inlet temperature sensor 402, and the motor temperature sensor 403. The lubrication cooling system provides the oil flow needed by the electric drive module that includes the gearbox 301, the motor housing 302, the bearing 303, the rotor shaft 304, the motor end windings 305 associated with the motor stator 306, and the motor rotor 307.

The selection and function of each component of the lubrication cooling system 100 are described as follows. The filter 101 removes the contaminants and debris of component wear in the gearbox 301. The electric oil pump 102 pushes the oil to flow in the lubrication cooling system 101. The oil cooler 103 is a water-oil heat exchanger, which extracts the heat from the oil through heat exchange between the oil and the coolant flowing through inlet 201 and outlet 202. The pipe system 104 provides the flow passages that connect the components of the lubrication cooling system 101. The one-way valve 105 determines the state of cooling flow towards the motor end windings 305. The inlet of motor cooling plumbing 106 provides the entry of cooling flow of the motor end windings 305. The shaft oil circuit 111 provides the flow passages for cooling of the motor rotor 307 and for lubrication of the gearbox 301.

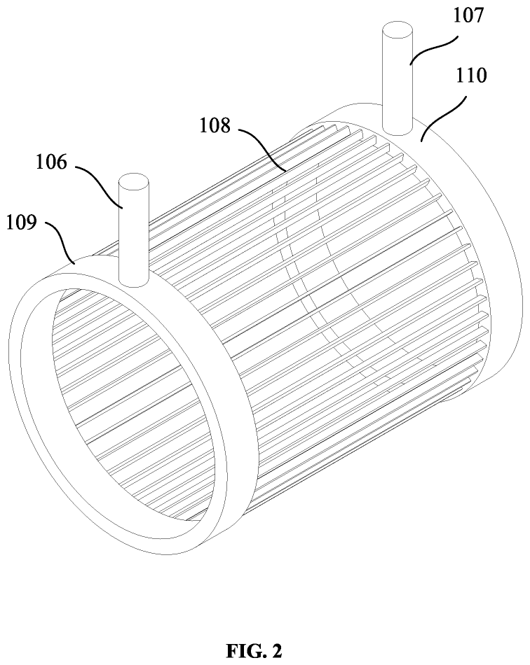

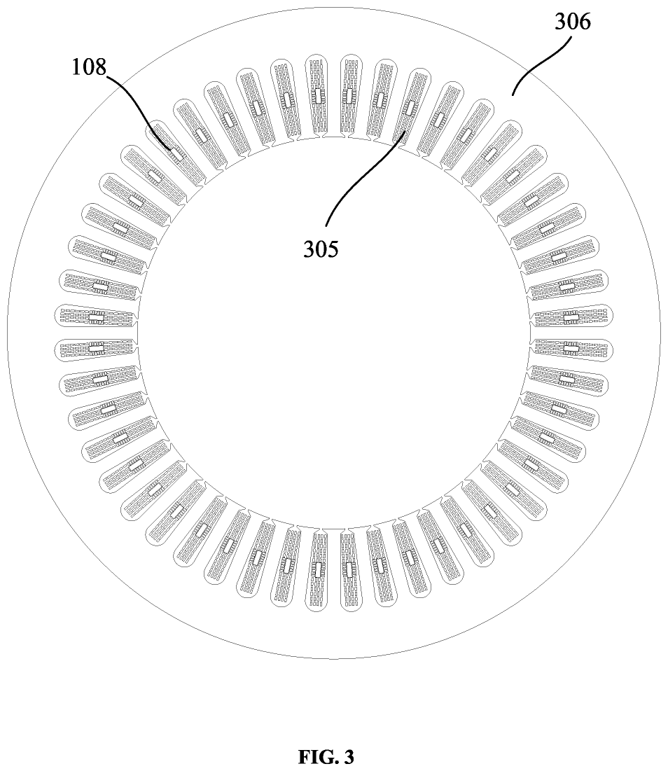

FIG. 2 and FIG. 3 are schematics of a cooling design of the motor end windings 305 in the lubrication cooling system 100 shown in FIG. 1. FIG. 2 is a three-dimensional schematic of the motor winding cooling design geometry in FIG. 1. The motor winding cooling design geometry includes the inner cooling channels 108, the left oil ring channel 109, the right oil ring channel 110, the inlet of motor cooling plumbing 106, and the outlet of motor cooling plumbing 107. The outlet of motor cooling plumbing 107 provides the exit of cooling flow of the motor end windings 305. The inner cooling channels 108 provide the flow passages for end winding cooling. The left oil ring channel 109 connects the inlet of motor cooling plumbing 106 and the inner cooling channels 108. The right oil ring channel 110 connects the outlet of motor cooling plumbing 107 and the inner cooling channels 108. FIG. 3 is a cross-section schematic of the motor cooling channel shown in FIG. 2. The inner cooling channels 108 are placed at the center of every stator slot and surrounded by the motor end windings 305 with direct contact.

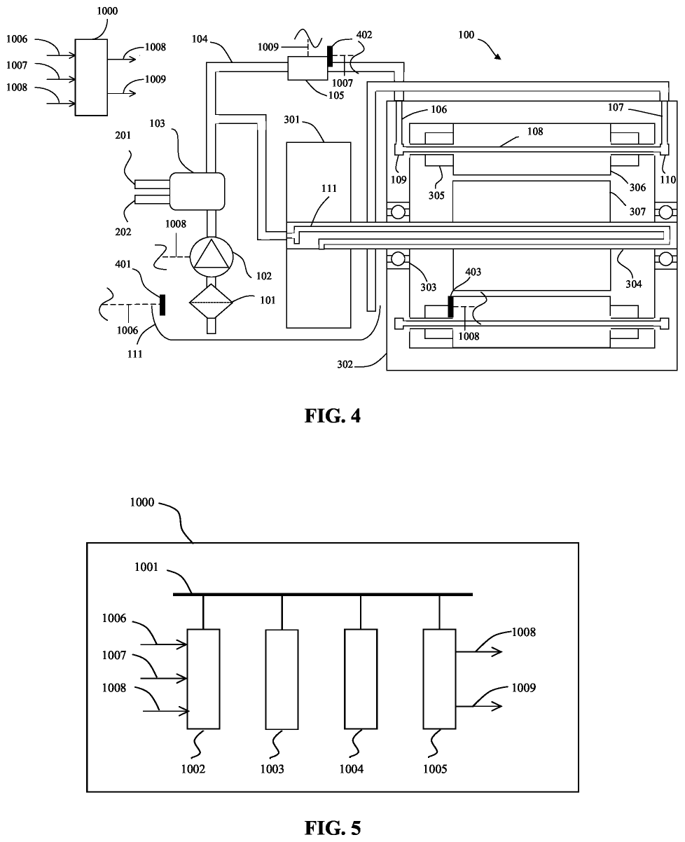

FIG. 4 shows an example of the signal communication between the control module and each illustrated actuator of the lubrication cooling system 100. The control module 1000 determines the working status of each actuator of the lubrication cooling system 100. The control module 1000 takes the input signal 1006, 1007, and 1008 from the sump temperature sensor 401, the motor cooling inlet temperature sensor 402, and the motor temperature sensor 403, respectively. The output signal 1009 is connected to the electric oil pump 102 and the output signal 1010 is connected to the one-way valve 105.

FIG. 5 illustrates an example of the internal structure of the control module 1000 shown in FIG. 2. The control module 1000 of the lubrication cooling system 100 includes the can bus 1001, the input interface 1002, the memory 1003, the processor 1004 and the output interface 1005. Specifically, the input interface 1002 receives the operation request and other operation parameters; the memory 1003 is used to store instructions and data; the processing 1004 reads instructions and data from the memory 1003 and can write data to the memory 1003; and the output interface 1005 sends the control signals to each actuator.

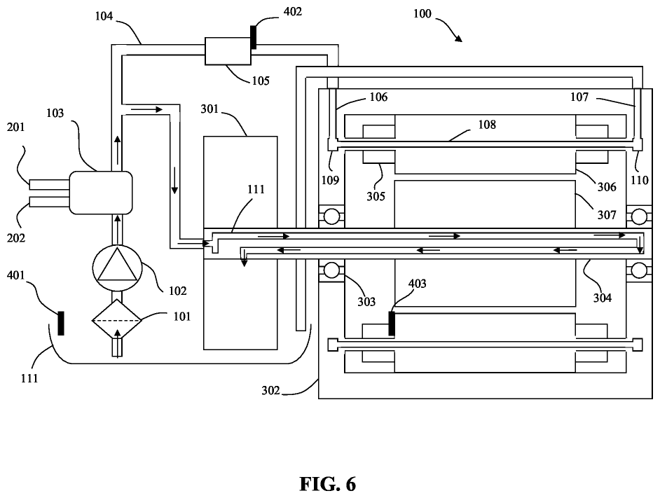

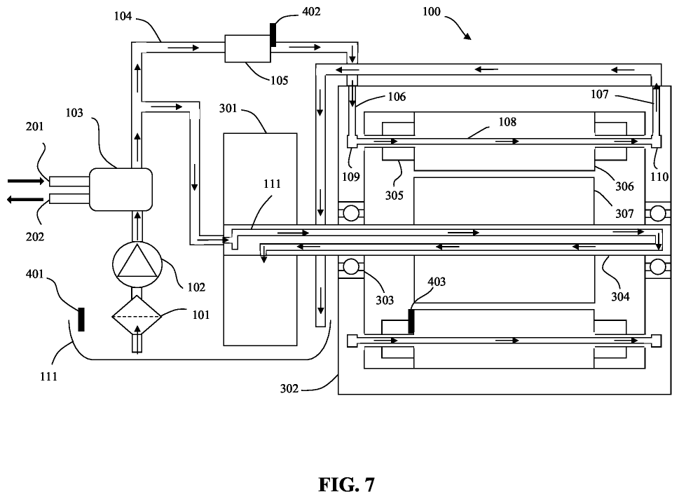

FIG. 6 and FIG. 7 illustrate examples of operation diagrams of the lubrication cooling system 100 shown in FIG. 1 to illustrate the fluid flow states of the lubrication cooling system 100 in different operating modes. The line arrows indicate active oil flow. The bold line arrows indicate active coolant flow. Each working mode will be described in detail as set forth below.

FIG. 6 shows the power-saving mode of the lubrication cooling system 100 at low and medium system temperatures. The lubrication cooling system 100 shuts off the cooling flow towards the motor end windings 305 with one-way valve closing. Therefore, the oil pumped out from the electric oil pump 102 passes through the oil cooler 103, the shaft oil circuit 111 inside the rotor shaft 304 and reaches the gearbox 301 to lubricate the rotational components such as bearings and gears. The oil splash due to the centrifugal effect will facilitate uniform lubricant distribution inside the gearbox 301. Eventually, the oil returns to the sump 111 due to gravity.

FIG. 7 shows the high-power mode of the lubrication cooling system 100 at high system temperatures. The lubrication cooling system 100 enables the cooling flow towards the motor end windings 305 with one-way valve opening. Therefore, the oil pumped out from the electric oil pump 102 passes through the oil cooler 103 and is split into two flow branches: the oil in the first branch enters the shaft oil circuit 111 to lubricate the gearbox 301 as depicted in FIG. 6; the oil in the second branch passes through the one-way valve 105 and enter the inlet of motor cooling plumbing 106 to reach the inner cooling channels 108. At the inner cooling channels 108, the oil extracts heat from the motor end windings 305 and the motor stator 306, and then exits at the outlet of motor cooling plumbing 107 to return to the sump 111.

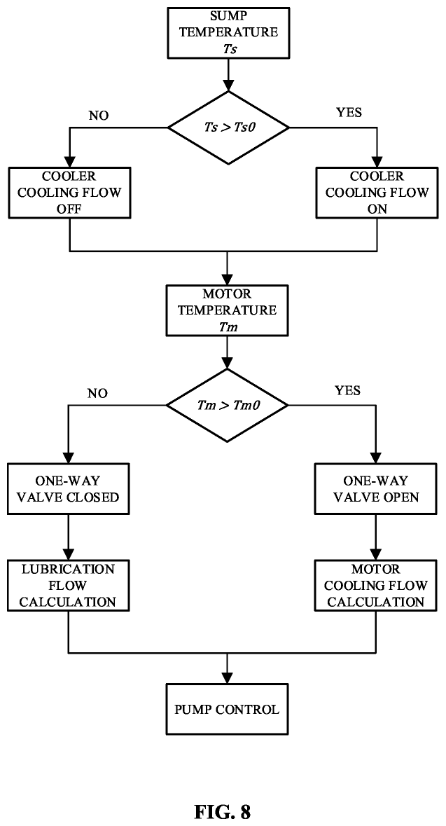

FIG. 8 is an example control flow diagram of the lubrication cooling system 100 shown in FIG. 1 and shows an example thermal management strategy that determines the system operational state. Firstly, the sump temperature Tₛ obtained by the sump oil temperature sensor 401 will be compared with Tₛ₀ to determine if the coolant flow is enabled. If the coolant flow is on, the oil will be effectively cooled with the oil cooler 103 with extra energy consumption by the coolant loop. Secondly, the motor temperature Tₘ obtained by the motor temperature sensor 401 will be compared with Tₘ₀ to determine if the one-way valve 105 is open. At a closed state of the one-way valve 105, only lubrication flow requirement is calculated to control the speed of the electric oil pump 102. Otherwise, both the lubrication and the cooling flow requirements are calculated for pump speed control.

The lubrication flow requirement Q_{L} is calculated as:

$${Q}_{L} = \sum {Q}_{{B}_{i}} + \sum {Q}_{{G}_{i}} \qquad ( 1 )$$

where the bearing flow requirement Q_{B}_{ᵢ}(i=1, 2, . . . N_{B}) and the gear flow requirement Q_{G}_{ᵢ}(i=1, 2, . . . N_{G}) are independent, and the component flow is assumed not to be recirculated through flow in series.

The cooling flow requirement Q_{C} is determined by:

$${Q}_{c} = \frac{1}{α ( {T}_{m} - {T}_{mc} )} ( {K}_{P} ( {T}_{m 0} - {T}_{m} ) + {\int }_{0}^{t} {K}_{I} ( {T}_{m 0} - {T}_{m} ( τ ) ) dτ ) \qquad ( 2 )$$

where T_{mc} is obtained by the motor cooling inlet temperature sensor 402; α is the coefficient related to motor convective cooling, and K_{P} and K_{I} are the PI controller coefficients.

The total pump flow is the sum of the lubrication and the cooling flow:

$${Q}_{P} = {Q}_{L} + {Q}_{C} \qquad ( 3 )$$

Since the pump flow is a function of the pump speed and the oil temperature, the pump speed n_{P} is obtained by a lookup table n_{P}(Qₚ, Tₛ) that is setup through test bench or simulation of computational fluid dynamics.

As used herein, the terms “comprise”, “comprising”, “includes”, “including”, “has”, “having” or any contextual variants thereof, are intended to cover a non-exclusive inclusion. For example, a process, product, article, or apparatus that comprises a list of elements is not necessarily limited to only those elements but may include other elements not expressly listed or inherent to such process, product, article, or apparatus. Further, unless expressly stated to the contrary, “or” refers to an inclusive or and not to an exclusive or. For example, a condition “A or B” is satisfied by any one of the following: A is true (or present) and B is false (or not present), A is false (or not present) and B is true (or present), and both A and B is true (or present).

It will also be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

It also will be appreciated that the term “controller” or “module” as used herein refers to any suitable control device or set of multiple control devices that is/are configured to perform at least a portion of the techniques of the present disclosure. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present disclosure. The one or more processors could be either a single processor or two or more processors operating in a parallel or distributed architecture.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known procedures, well-known device structures, and well-known technologies are not described in detail.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present application, its application or uses. Thus, variations that do not depart from the gist of the present application are intended to be within the scope of the present application.

What is claimed is:

1. A lubrication cooling system for an electric drive module of an electrified vehicle, the electric drive module including a motor shaft coupled to an electric motor and an associated gearbox, the lubrication cooling system comprising:
a fluid circuit for flow of lubrication and cooling oil including fluid pathways in communication with an electric oil pump, an oil cooler, a one-way valve, a stator cooling subcircuit, a rotor and gearbox cooling subcircuit, and a sensor system including a sump oil temperature sensor, a motor cooling inlet temperature sensor, and a motor temperature sensor;
wherein the stator cooling subcircuit includes an inlet coupled to a first oil ring channel, a plurality of motor end winding channels coupled at a first end to the first oil ring channel and at a second end to a second oil ring channel, and an outlet coupled to the second oil ring channel;
wherein the rotor and gearbox cooling subcircuit includes a motor shaft internal oil circuit extending inside the motor shaft along a longitudinal length of the motor shaft for cooling the rotor and a gearbox of the electric drive module; and
a control module in communication with at least the one-way valve and configured to selectively open and close the one-way valve to selectively provide lubricant flow to: i) both the rotor and gearbox cooling subcircuit and the stator cooling subcircuit, and ii) only the rotor and gearbox cooling subcircuit, respectively.

2. The lubrication cooling system of claim 1, wherein the control module communicates with the electric oil pump, the sump oil temperature sensor, the motor cooling inlet temperature sensor, and the motor temperature sensor.

3. The lubrication cooling system of claim 1, wherein the control module controls:
system operational state by controlling an open and close state of the one-way valve;
electric drive module system heat dissipation by determining a coolant flow state; and
the electric oil pump to meet determined system flow requirements.

4. The lubrication cooling system of claim 1, further comprising two system modes:
a power-saving mode where at low and medium system temperatures below a predetermined threshold, the power-saving mode controls the one-way valve to a closed state to shut off cooling of the motor end windings and provides lubrication flow for the rotor and components in the gearbox via the rotor and gearbox cooling subcircuit; and
a high-power mode where at high system temperatures above the predetermined threshold, the high-power mode controls the one-way valve to an open state to the lubrication flow to the gearbox via the rotor and gearbox cooling subcircuit and the cooling flow of the stator via the stator cooling subcircuit.

5. The lubrication cooling system of claim 1, wherein the plurality of motor end winding channels are placed at a center of a corresponding plurality of stator slots and surrounded by and in direct contact with motor end windings in the stator slots.

6. The lubrication cooling system of claim 5, wherein the first and second oil ring channels form circumferential ring channels having a radius spaced from a center of the motor shaft and that aligns with a corresponding radial spacing of the center of the plurality of stator slots.

7. The lubrication cooling system of claim 6, wherein the first and second oil ring channels are positioned proximate respective first and second opposed longitudinal ends of the stator motor end windings.

8. The lubrication cooling system of claim 1, wherein the rotor is directly coupled to the motor shaft and thereby dissipates heat from the rotor by convective lubricant cooling flow in the motor shaft internal oil circuit.

9. The lubrication cooling system of claim 1, further comprising the control module being configured to implement a thermal management strategy that determines the system operational state by comparing a sump oil temperature from the sump oil temperature sensor and a motor inlet oil temperature from the motor cooling inlet temperature sensor with predetermined threshold values.

10. The lubrication cooling system of claim 1, further comprising the control module determining a flow requirement for cooling of the electric drive module via the rotor and gearbox cooling subcircuit and the stator cooling subcircuit including a lubrication flow that meets a minimum flow requirement of the gearbox and a lubrication flow to achieve cooling of the electric motor to maintain a temperature of the electric motor below a predetermined temperature.
